(19) United States
(12) Patent Application Publication
(10) Pub. No.: US 2015/0026712 A1
(43) Pub. Date: Jan. 22, 2015

(54) INTEGRATION OF SOCIAL MEDIA WITH LIVE EVENTS

(71) Applicant: ROSS VIDEO LIMITED, Ottawa (CA)

(72) Inventors: Shawn Andrew SNIDER, Ottawa (CA); Charles Allan PEPPER, Ottawa (CA); Bradley Howard ROCHON, Oak Park, CA (US); Jeffrey Derek MOORE, Kanata, (CA); Emil SADOK, Ottawa (CA)

(21) Appl. No.: 14/505,554

(22) Filed: Oct. 3, 2014

Related U.S. Application Data
(63) Continuation of application No. 13/443,274, filed on Apr. 10, 2012.

(51) Int. Cl. H04N 21/462; H04N 21/4788; H04N 21/442

(52) U.S. Cl. CPC H04N 21/4622; H04N 21/44222; H04N 21/4788
USPC 725/14

(57) ABSTRACT

Apparatus and methods that provide for integration of social media with live events are disclosed. Social media content could be published to an online social media service responsive to the detection of a trigger that is associated with a live event video broadcast. In some embodiments, incoming user-driven social media content is repurposed and automatically reformatted for video display. Story content sources and citations might also be integrated for broadcast stories. Story content approval and notification could also be supported.

### CROSS-REFERENCE TO RELATED APPLICATION

This application is a continuation of U.S. patent application Ser. No. 13/443,274 filed on Apr. 10, 2012, the contents of which are incorporated in their entirety herein by reference.

### FIELD OF THE INVENTION

This invention relates generally to social media and live event video broadcasting, and in particular to integrating social media with live events.

### BACKGROUND

Television broadcast of live events, which include but are not limited to sports games, newscasts, talk shows, concerts, awards shows and so forth, might benefit from providing related updates and/or supporting audience feedback and discussion using social media.

Time-of-day scheduling of social media posts can provide for automated posting of content through social media. This type of scheduling could be used, for example, to post social media content that is related to a broadcast of a live event at certain times during the broadcast, such as at the scheduled start time of the broadcast, the scheduled end time of the broadcast, and/or at certain specific times between the scheduled start and end times. For live events, however, exact timing of broadcast activity, apart from the start time of a broadcast program, is not known in advance.

The social media content itself could be generated separately from a live event broadcast, even though a broadcast could include its own related text. For example, broadcast story text is unformatted and typically capitalized with production cues for display in a teleprompter device as an aid for delivery by on-air talent and hosts. Currently, in order to reuse broadcast story text content within a rundown for alternate story formats such as social media posts, manual editing and/or formatting is required.

### SUMMARY

An apparatus includes a trigger detector to detect a trigger associated with a live event video broadcast, and a publication module operatively coupled to the trigger detector, to publish social media content to an online social media service responsive to the detection of the trigger.

The apparatus might also include an interface to a broadcast system that broadcasts the live event video broadcast, in which case the trigger could be a trigger signal generated by the broadcast system.

The broadcast system could include one or more of: a rundown management system and a rundown playout engine.

In some embodiments, the social media content includes a portion of the live event video broadcast. The trigger detector might then detect, as the trigger, completion of broadcast of the portion of the live event video broadcast.

The apparatus could include an interface to receive the live event video broadcast, and a memory operatively coupled to the interface and to the publication module to record, during broadcast, a portion of the live event video broadcast. Where the social media content includes the portion of the live event video broadcast, the trigger could be completion of recording of the portion of the live event video broadcast.

The apparatus also includes an interface to enable communication with a user in some embodiment. The publication module could then publish the social media content only after receipt of approval of the social media content from the user through the interface.

A content converter could also be included in the apparatus to convert content into the social media content for publication. The content converter could convert the content into a plurality of respective formats for publication to a plurality of social media services responsive to detection of the trigger.

In some embodiments, the publication module determines whether the social media content is dependent upon completion of an event in addition to detection of the trigger, and delays the publishing of the social media content until completion of the event where the social media content is dependent upon completion of the event.

The apparatus could include an interface to enable communication with a social media user, in which case the publication module could receive incoming social media content from the social media user, and publish the incoming social media content to the live event video broadcast.

A method involves detecting a trigger associated with a live event video broadcast, and publishing social media content to an online social media service responsive to the detection of the trigger.

The live event video broadcast could include segments in a rundown broadcast by a broadcast system, in which case the trigger could be a trigger signal generated by the broadcast system.

As noted above, the broadcast system could include one or more of: a rundown management system and a rundown playout engine.

The social media content could include a portion of the live event video broadcast. The trigger could then be completion of broadcast of the portion of the live event video broadcast.

In some embodiments, the method also involves recording, during broadcast, the portion of the live event video broadcast, and the trigger is completion of recording of the portion of the live event video broadcast.

The method could also involve requesting approval of the social media content prior to the publishing, with the publishing being subject to receipt of approval of the social media content.

The publishing could include publishing social media content to a plurality of social media services responsive to detection of the trigger.

In some embodiments, the method includes determining whether the social media content is dependent upon completion of an event in addition to detection of the trigger, and delaying the publishing of the social media content until completion of the event where the social media content is dependent upon completion of the event. The event could be publication of additional social media content that is referenced in the social media content.

The method could also include receiving incoming social media content, and publishing the incoming social media content to the live event video broadcast.

A non-transitory computer-readable medium could be used to store instructions which when executed perform such a method.

Other aspects and features of embodiments of the present disclosure will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of an example apparatus that handles social media content.

FIGS. 2 to 6 illustrate example graphical user interfaces.

FIG. 7 is a flow diagram illustrating an example method.

### DETAILED DESCRIPTION

As noted above, the present patent application relates to integrating social media with live events. Examples of social media include but are in no way limited to Twitter, YouTube, Brightcove, Facebook, and Tumblr. In general, social media would encompass services or forums which support electronic social interaction between users, and also provide for sharing of electronic content. For example, electronic content could be in the form of a video clip posted to a social media service and subsequently viewed and commented on by one or more users of that social media service.

Live events such as sports games, newscasts, talk shows, and concerts to name a few, are typically preprogrammed and cut into a list of smaller segments, referred to as a rundown. Each of these segments, which may in turn include one or more stories, is named and can have information attached to it. A rundown might thus include a pre-planned script of stories that could be grouped into segments and are created for a broadcast and are aired in a semi-timed manner. Segments within a rundown often have variable duration which cannot be known before the segment occurs. The exact timing of when these live segments or stories might be brought to air and/or when airing of each segment or story might be complete is not fixed. The duration of the answer to a question cannot be known in advance of the question being asked and answered, for example. In this manner, while the overall flow and order of segments within a live event can be planned, it is impossible to know in advance at exactly what time a particular segment or story will commence and complete.

As disclosed herein, social media activity, such as social media posts, can be coordinated with airing of segments and/or stories during a live event, even though exact timing of such segments and stories might not be known in advance.

This type of coordination could be provided through integration of a content publishing system with an external synchronization trigger, and manual operation could be supported as well.

In some embodiments, social media content could also or instead be dragged-and-dropped into a managed queue and then repurposed for video display, via a character generator system for instance. This drag and drop action could include transformation of social media content in the queue into a format appropriate for a broadcast model.

Social media content could be referenced with a list of source citations associated with a segment and/or part of a segment such as a story, in a rundown. Authorization for publishing social media content is enforced in some embodiments via a content approval and notification workflow model.

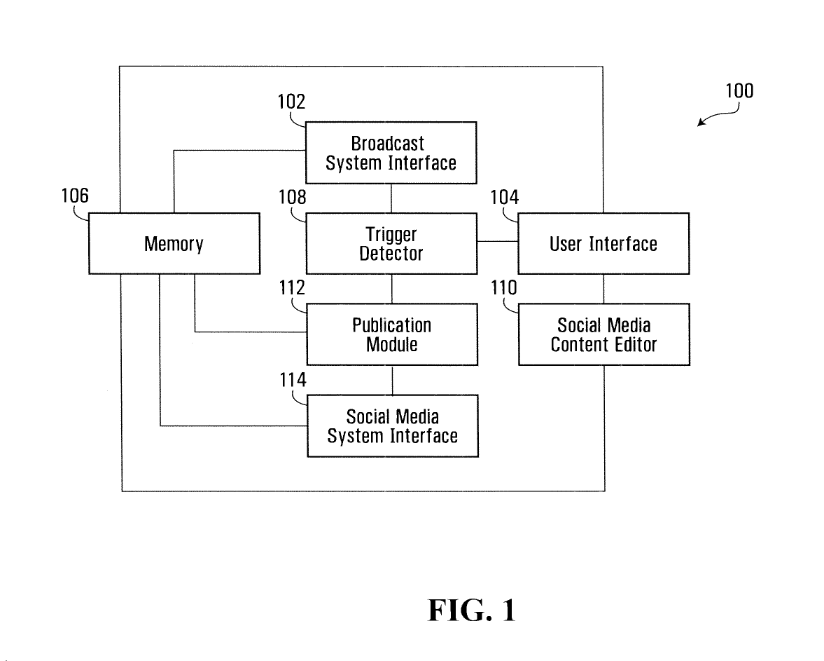

FIG. 1 is a block diagram of an example apparatus that handles social media content. The example apparatus 100 includes a broadcast system interface 102, a user interface 104, a memory 106, a trigger detector 108, a social media content editor 110, a publication module 112, and a social media system interface 114. It should be appreciated that the example apparatus 100 of FIG. 1, as well as the contents of the other drawings, are intended solely for illustrative purposes, and that the present disclosure is in no way limited to the particular example embodiments explicitly shown in the drawings and described herein. Actual implementations may include fewer, additional, and/or different components operatively coupled together in a similar or different manner.

The interconnections shown in FIG. 1 may take any of various forms. For example, components could be interconnected through cables or other types of physical conductors, wireless links, shared memory locations that are accessed by different components, and/or software variables or registers that are used by different components, Other types of connections could be used in other embodiments, and may be implementation-dependent.

The interfaces 102, 104, 114 are shown separately in FIG. 1 solely for illustrative purposes. A single physical interface could implement more than one of the interfaces of the example apparatus 100. For instance, the example apparatus 100 could potentially communicate with both a user and a social media system through a single network interface instead of through separate interfaces as shown at 104, 114. In general, each interface 102, 104, 114 includes at least a physical component such as a port or connector, and possibly additional components that support communications over some sort of communication link.

The broadcast system interface 102, for example, could potentially be a cable jack or other form of connector to a physical conductor that connects to a broadcast system. This type of interface might be feasible where the example apparatus 100 is co-located with the broadcast system. The broadcast system interface 102 could also or instead include a network port for communication with the broadcast system. In some embodiments, the example apparatus 100 is integrated into the broadcast system, in which case the broadcast system interface 102 could be an interface to an internal bus, backplane, or other interconnection structure within broadcast system equipment.

The social media system interface 114 could similarly include any of various types of physical interface. A single interface, or multiple interfaces, could be provided to enable communications with multiple social media systems. Although in many embodiments social media content publication would likely be provided by a live event broadcaster or an entity affiliated with the broadcaster, it is possible that such content publication could be integrated into a social media system, in which case the social media system interface 114 could be an interface to an internal equipment interconnection structure.

Regarding the user interface 104, this interface could also include one or more physical interfaces of various types. The example apparatus 100 could potentially incorporate user interface devices, such as a display screen, a keyboard, and a mouse or other pointing device, to provide outputs to and receive inputs from a user. The example apparatus 100 could also or instead support external communications with a user, through a network interface for example. User interface devices at a user system could then allow interaction between a user and the example apparatus 100 as described herein, through a network connection.

The memory 106 could include one or more solid-state memory devices and/or memory devices that use movable or even removable storage media. Although shown as part of the example apparatus 100, storage of social media content could be external to the apparatus and accessible through a network interface or other type of interface, for example.

The trigger detector 108, the social media content editor 110, and the publication module 112 could be implemented using hardware and/or firmware, and could include one or more components that execute software. For example, a microprocessor could execute software, stored in the memory 106 or elsewhere, to implement any or all of the trigger detector 108, the social media content editor 110, and the publication module 112.

The example apparatus 100 may address current rundown content system limitations by providing a publishing platform for creating, editing and publishing social media content directly from a traditional rundown event story. Such features as: automatic content formatting applied to a reference broadcast story, asynchronous publishing of content to social media web-services at any time during an event, and/or synchronous publishing of social media content that leverages an external event triggered synchronization model, may be provided. A synchronous rundown playout engine or other form of broadcast system, for example, could provide the ability to publish social media content in parallel with a live event as segments or stories are broadcast and integrate with an external rundown control system, and also potentially enable manual control of social media content publishing by a user.

Social media content could be stored in the memory 106 in some embodiments. Such content could also or instead be stored separately, and possibly along with broadcast rundown story content. A content management system, for example, could be deployed as a web server or as a dedicated application. Clients, including the example apparatus 100, then access the management system and its content, illustratively via a network interface and network connection. Such access could be provided through a web-based user interface and one or more user interface devices at 104, or via a standalone client application, for example.

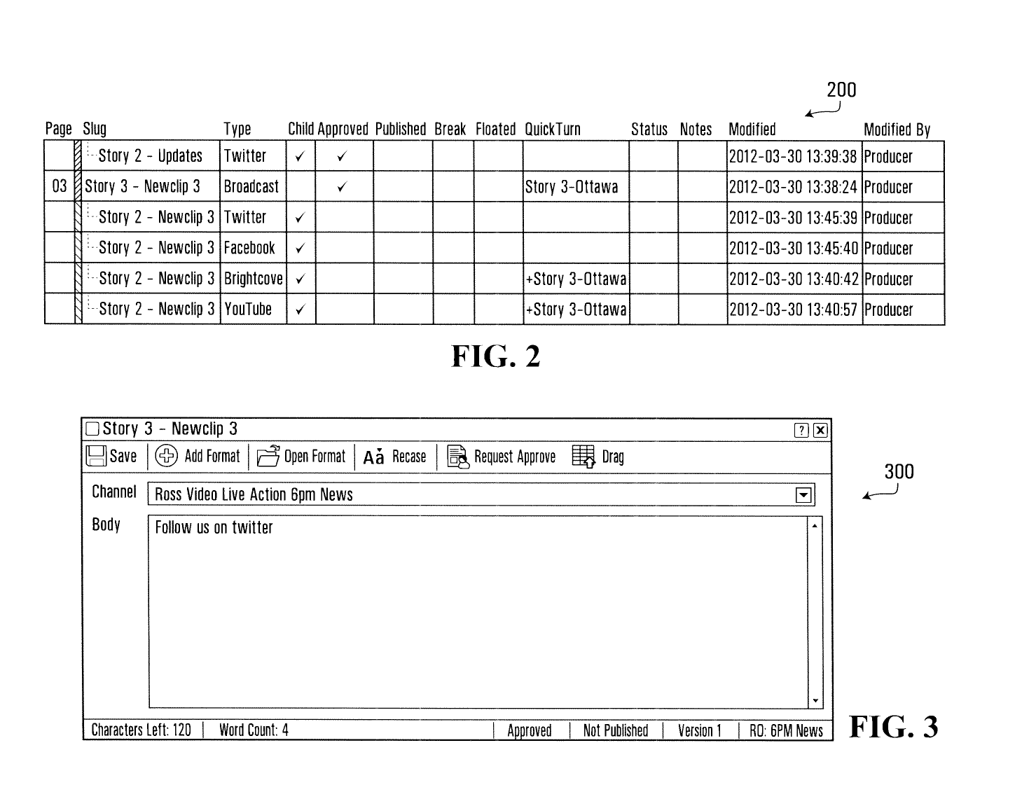

FIG. 2 illustrates an example GUI (graphical user interface) 200 that provides a tabular view of story content and related social media content for a live event video broadcast production. This type of tabular view of story content, in a broadcast system, is referred to as the rundown or a running order, and could be similarly referenced in a social media content publication system. A GUI such as 200 could be presented to a user through a local or remote user interface device at 104, and support a scripting workflow or otherwise enable preparation of a segment or story script, and/or a content creation and editing utility for managing multiple versions of social media content that is associated with a story, for example. Social media content creation and editing is provided in the example apparatus 100 by the social media content editor 110. Running order creation and/or editing could also be provided by the social media content editor 110. Running orders for social media content could also or instead be imported from a rundown creation system. An imported rundown could be a rundown from a broadcast system, which could be edited to include additional entries for social media content stories associated with broadcast segments or stories in the broadcast rundown.

In the example GUI 200 shown in FIG. 2, the running order includes a number of broadcast and social media stories which can be grouped via a parent-child story hierarchy. The children of each broadcast story “node” in this example are alternative formatted story types, in the form of social media story content for different social media services. With reference to FIG. 2, “Story 3-Newsclip 3” is a parent broadcast story, There are four child social media stories, including one for each of Twitter, Facebook, Brightcove, and YouTube. The different types of child social media stories could also or instead by identified by using different icons in each story row in the rundown. In this example rundown, publication of the four child media stories is to be coordinated with broadcast of the parent story.

This example rundown illustrates another aspect of the present disclosure as well. As noted above, a user might create and/or edit social media content. Another source for social media content could be the a live event video broadcast itself. The child social media content stories in FIG. 2 could be different formats of the broadcast story, formatted for the different social media services. With reference back to FIG. 1, the broadcast story could be received through the broadcast system interface 102 and recorded in the memory 106 or a separately hosted content system. Format conversion for different social media services could be performed, for example, by the social media content editor 110 or the publication module 112. In one embodiment, broadcast story content is received through the broadcast system interface 102, stored to a database in the memory 106 or elsewhere, and subsequently pushed to the social media content editor 110 for format conversion and/or other processing prior to publication by the publication module 112.

Publishing of story content or other content to social media could be subject to approval by an authorized user. An approval and notification workflow model could be used, for example. In this type of model, broadcast system users IC and/or creators of social media content can request approval for content, or request approval and initiate a publishing request, from authorized users. These requests could be initiated via an approval request or publish request action invoked from a graphical story editor, such as the social media content editor 110 in FIG. 1. An approval request or publish request could relate to broadcast story content or social media content. In the example GUI 200 shown in FIG. 2,

An approval or publish request could be transmitted via a notification e-mail or SMS (short message service) message, for example, to one or more story content approvers. An approver can then issue an e-mail or SMS response as a follow-up to a story approval request. Approval status is then updated for the story within a running order (i.e., indicating that a broadcast story or social media story is approved), which ultimately allows for publishing story content to a social media service. In the example GUI 200, approval of the broadcast story 3 is indicated by a check mark in the “Approved” column. Where approval is required for social media content, approval status could be indicated in the “Approved” column for each child story. The publishing module 112 publishes social media content only after receipt of approval from an authorized user, where an approval mechanism is provided. In the example shown in FIG. 2, approval of the broadcast story constitutes approval of the child social media stories.

Publishing of social media content can be invoked synchronously via sequential playout of each child story in the running order, or asynchronously via directly publishing a story. Asynchronous publishing could be invoked using Publish buttons or other functional graphical elements located in a story editor or running order editor GUI provided by the social media content editor 110, for example.

Examples of GUI-based approval and publishing of social media content are shown in FIGS. 3 to 5.

With reference to FIG. 3, the example GUI 300 could be displayed to a user of the social media content editor 110 (FIG. 1) during creation of social media content. In the example shown, the Twitter “Story 3-Newsclip 3” child social media story is being edited by the user. When the story is complete, the user may request approval by clicking on the “Request Approval” graphical element, which is shown as a button in this example. An approval request could then be transmitted to one or more story content approvers.

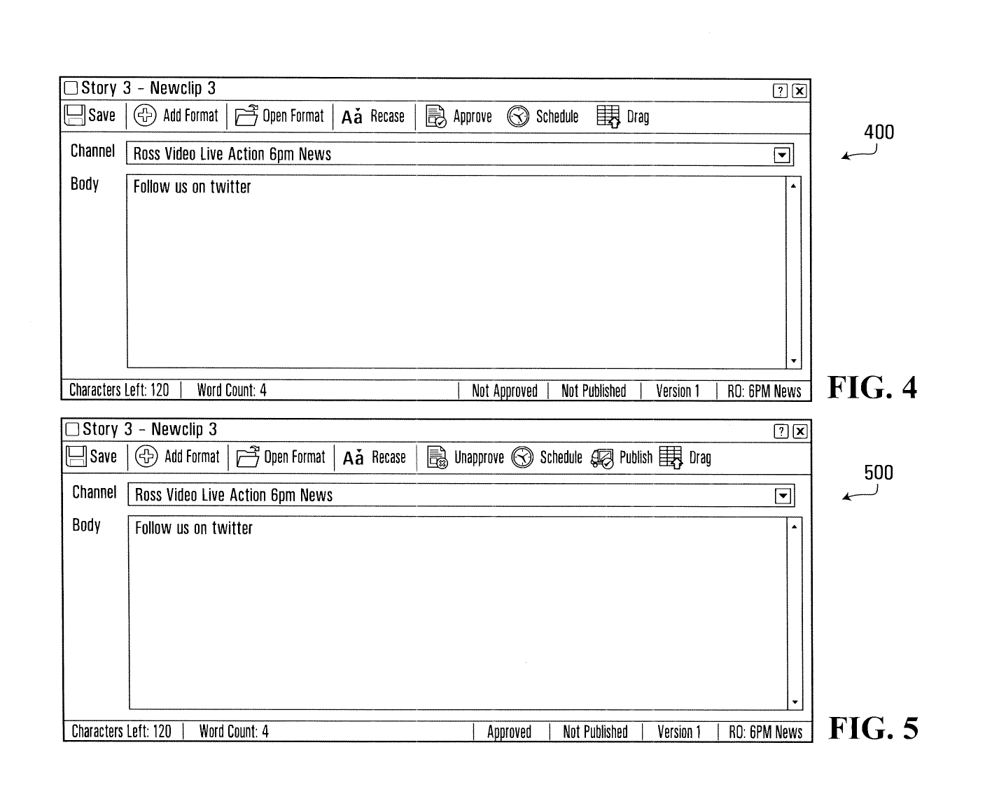

Although approval could potentially be granted through a reply email or SMS message in some embodiments, an example GUI 400 which provides for story content approval is shown in FIG. 4. After receiving a request approval notification, a story content approver could log in or otherwise access the social media content editor 110 (FIG. 1) and approve the story content for the child social media story “Story 3-Newsclip 3” by clicking on the “Approve” graphical element, which is shown as a button in the example GUI 400.

After approval, a status indicator at the bottom of the example GUI 400 could be updated, as shown in the example GUI 500 in FIG. 5, from “Not Approved” to “Approved”. The “Approve” graphical element could also change to “Unapprove” in order to provide an option to revoke approval of approved social media content. FIG. 5 also illustrates an additional graphical element, in the form of a “Publish” button in this example, to initiate publishing of the approved social media content. The presence of this graphical element, and/or the status indicator “Not Approved”, informs the user that the story content has not yet been published.

FIGS. 3 to 5 have been described above primarily in the context of story approval and publishing. Several other graphical elements are also shown in FIGS. 3 to 5. The “Channel” pulldown menu allows a user to determine to which social media account the story will be published. For example, users might be allowed to configure multiple Twitter/Facebook accounts or “Channels”, and the pulldown menu denotes to which of the specific accounts the story will be published. The “Save” button is used to save a social media story, to the memory 106 (FIG. 1) and/or elsewhere. The “Add Format” button enables a user to create an additional output format for the social media content. If a social media story is being prepared for publication to Facebook, for example, then an additional output for Twitter could be created using the “Add Format” button. The “Open Format” button allows a user to open and edit the content for a specific output of a story. The “Recase” button could be used, for example, to convert uppercase teleprompter text content to lowercase or sentence case for publishing to social media. The “Schedule” button allows a user to schedule publication of a story based on a fixed date and time. For example, a user could schedule a Twitter story to go “live” (i.e., publish) at 5:30 PM on a specific date. Finally, the “Drag” button represents a handle that allows a user to drag the story into a running order.

The status indicators at the bottom of the example GUIs 300, 400, 500 include indicators for remaining characters, labelled as “Characters Left”, which could be useful where social media content is limited to a maximum size. The “Word Count” indicator could also be useful when textual content is being prepared. The “Version” status indicator enables a user to track content versioning, and the “RO” item in the status bar indicates which running order the story is a part of, if any.

In addition to manual publishing using a “Publish” button or a “Schedule” button as described above, an automated approach for publishing content could be supported, whereby a synchronous playout of a social media running order is coordinated with a live event video broadcast. A trigger associated with the live event video broadcast is detected by the trigger detector 108, and social media content is published to a social media service by the publication module 112 responsive to the detected trigger. The trigger could be received through the broadcast system interface 102 from an external broadcast system, such as a broadcast rundown management system, a broadcast rundown playout engine, or an automated production control system. This approach allows users to manage their live events production and playout via existing rundown systems or automated production control systems and leverage automatic publishing of social media story content as disclosed herein.

Various features of embodiments of the present disclosure are described briefly above. The following features are discussed in further detail below:
1. automated publishing of story content to external social media services;
2. repurposing and automatic reformatting of user-driven social media content for video display, illustratively via a character generator;
3. story content sources and citations integration for broadcast stories;
4. story content approval and notification workflow, which could be based on e-mail or SMS mobile notifications.

An external event trigger mechanism from existing broadcast systems, such as rundown management or playout systems or automated production systems, could be supported. For example, “on-air” and “take story” status requests from a broadcast system could be received through the broadcast system interface 102 (FIG. 1), and detected by the trigger detector 108 as a trigger. Responsive to detection of the trigger, the publication module 112 publishes social media content, which might include all or a portion of the broadcast content, to one or more external channels, such as social media web-services including video hosting web-services.

Broadcast systems are used to manage the flow of a live event. As noted above, a broadcast rundown is a list of ordered segments within the event. As the event progresses, when a new segment or story starts for example, a broadcast system could send asynchronous messages to a social media publishing platform informing it as to which segment has commenced. A broadcast system could also or instead inform a social media publishing platform at the end of a broadcast segment, when broadcast of a story begins, and/or when broadcast of a story ends. Other coordination points for coordinating social media activity with broadcast are also possible. In the example apparatus 100 in FIG. 1, trigger messages could be received from a broadcast system through the broadcast system interface 102 and are detected as triggers by the trigger detector 108, to trigger publication of social media content by the publication module 112.

It should be noted that a broadcast system need not necessarily generate explicit messages to trigger social media activity. The trigger detector 108 could passively “listen” for triggers. For example, broadcast segments or stories could be recorded as they are aired, with the trigger detector 108 detecting, as a trigger, completion of recording of a segment or story. During recording of a segment or story, a file in the memory 106 could be in a locked or inaccessible state. The trigger detector 108 could detect a state transition in the file state after recording is completed, or otherwise be notified of completion of recording. The recorded segment or story could then be published to a social media service by the publication module 112. In this mode, the tracking of which segment or story is currently in progress is performed by the social media platform itself, based on triggers that are not externally generated explicit triggers from the broadcast system. Publication of social media could also or instead based on other types of detected triggers.

Another possible passive listening approach for trigger detection could involve receiving and monitoring control signals that are used within a broadcast system to control the live event broadcast. The “on-air” and “take story” status requests noted above represent examples of existing control signalling that could be received through the broadcast system interface 102 for trigger detection by the trigger detector 108.

Manual interaction with a user through a user interface 104 to control publication of social media content is also contemplated.

References to publishing to a social media service should not be taken as restricting to publication to only one such service. A broadcast segment or story could have multiple associated child stories, as shown in FIG. 2. Each child story could have its own text and media content, as well as a social media destination target to which it is to be published. Child stories associated with a broadcast segment or story may be for the same or different targets. In the example shown in FIG. 2, there are four child stories for the broadcast rundown entry “Story 3-Newsclip 3”, each with a different destination target.

When the trigger detector 108 (FIG. 1) detects a trigger such as a notification that broadcast of a segment has commenced, the publication module 112 may publish all, or a subset, of the child stories associated with that segment. In this manner, social media content publication can appear concurrently with the airing of broadcast segments within a live event broadcast.

Publication of child stories may be coordinated with broadcast of their parent story. This is illustrative of a form of dependency, in that in some embodiments the child stories are not published until the parent broadcast story is taken to air. There may be other types of dependent events.

For example, story dependencies could prevent publishing of a specific social media story until all of its prerequisites are met. Suppose that a Twitter story contains a link to a YouTube story that has not yet been published. If the trigger detector 108 detects a request or other trigger to publish the Twitter story, because it contains a link to the YouTube story video that is not yet published, it is dependent on that that story. After the YouTube story is published, the publication module 112 can automatically substitute the link to the published YouTube story in the Twitter story, and then publish the Twitter story. In this manner, the publication module 112 may determine whether social media content (the Twitter story in this example) is dependent upon completion of an event (publication of the YouTube story) in addition to the trigger, and delay publishing until completion of the event where there is a dependency.

Some embodiments might handle incoming social media content. A managed lightweight running order could include external user-driven social media content and allow user to drag-and-drop social media content into a managed queue. The managed queue provides a mechanism that enables a user to filter incoming social media content and publish this incoming external user-driven social media content to a character generator system within the broadcast system for video display, such as in a news crawl or sports mode.

This is generally referred to herein as “repurposing” user-driven social media content for video display.

In one embodiment, the social media platform subscribes to social media feeds, which can be transformed into a visual and video display via a graphics device. External social media content can then be ingested and managed within the social media platform. For example, incoming social media content could be received through the social media system interface 114 (FIG. 1) and stored in the memory 106. Incoming social media content that is to be brought to air could be dragged-and-dropped into a monitored queue which could be provided within the memory 106 or separately. In the monitored queue, incoming user-driven social media could be approved, and then transformed into a video ready format via a character generator, for example. The character generator or other graphics device that performs this conversion could be part of a broadcast system in conjunction with which the example apparatus 100 operates, and in this type of implementation approved incoming social media content could be provided to the broadcast system through the broadcast system interface 102. Although not explicitly shown in FIG. 1 to avoid congestion in the drawing, the publication module 112 could be operatively coupled to the broadcast system interface 102 for publishing incoming social media content to air. A character generator or other graphics device that is used in taking incoming social media content to air could be part of the broadcast system, or separate from the broadcast system in other embodiments.

Such repurposing of incoming social media content may provide an automated approach in which the incoming content is filtered via a global blacklisted words lookup, for example, and transformed into a graphics ready format for display on video. Automatic text formatting between various standard broadcast formats, social media formats, and character generator formats could be implemented in the example apparatus 100 and/or at a broadcast system to drastically reduce the time and workload of users in taking incoming social media content to air.

Incoming social media content could be managed by a user through a GUI. As noted above, incoming social media content could be locally stored in the memory 106, illustratively within a database in the memory. A GUI could be used to show all of the incoming social media content for review by a user. Separate items of incoming social media content could be represented by respective icons, for example, which can then be selected and dragged-and-dropped with a mouse, into a separate moderated and monitored queue UI window.

The queue GUI window resembles a lightweight running order, and could be similar GUI 200 in FIG. 2, in some embodiments. The monitored queue provides a staging area for: sequencing and sorting the incoming social media content, filtering the incoming social media content for global blacklisted content (e.g., words), and an approval mechanism for authorizing content to be published to air. A user can publish approved story content to a broadcast system through the publication module 112 and the broadcast system interface 102 (FIG. 1), for example, whereby the incoming social media content is transformed into a graphics ready format which can be interpreted by a character generator or other graphics component for visual display as part of a video broadcast.

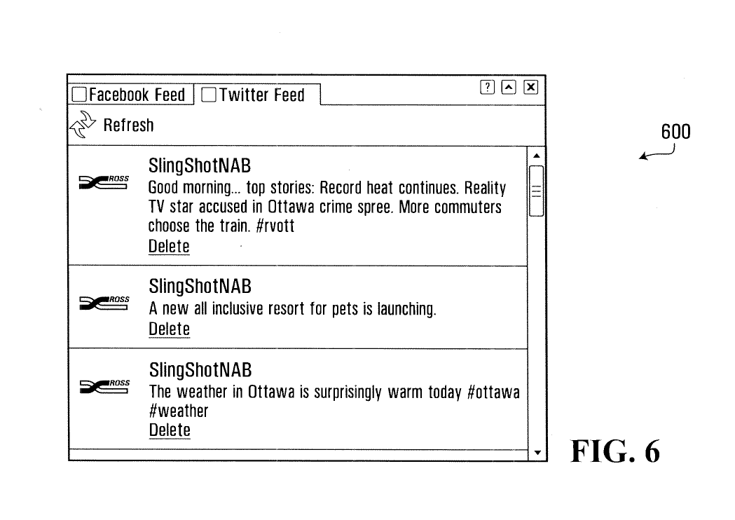

FIG. 6 shows an example of a Feeds GUI 600 that could be displayed to a user to enable management of social media feeds. In this example, there are two feeds. Entries in each feed could be dragged and dropped into a monitored queue GUI, which as noted above might resemble a lightweight running order similar to the example GUI 200 in some embodiments. A user could click on an item in the example Feeds GUI 600 and drag it into a queue GUI to initiate the process of taking the incoming social media content to air.

In summary, a moderated and monitored queue could act as a lightweight running order, providing the ability to reorder and prioritize content for publishing to a character generator and to apply content filtering for authorizing user-driven social media content posts as part of a video broadcast. The published incoming social media content would be displayed as part of a live broadcast video feed, such as in the lower third of a display screen, in a sports mode, and/or in a social media “ticker” format.

Some embodiments may enable content writers and editors to add source material for a broadcast story within a running order and link reference material for each broadcast story. An automated list of citations could be created for a running order based on the story references associated with each broadcast story in the running order, for example.

During the content creation, editing, and approval process for a live event, users could also or instead add story content sources and citations. For example, a content writer or editor might provide external content URL (uniform resource locator) links and/or upload supporting material for a broadcast story in order to associate reference material with a story. Referenced content can be associated with each story, and stored within a social media publishing platform database, illustratively in the memory 106 in the example apparatus 100 (FIG. 1). Supporting content could also be accessible via a broadcast story editor and stored as part of the broadcast story even when duplicated across multiple show running orders (e.g., shows airing at 5 pm, 6 pm, 11 pm). In addition, the social media publishing platform could employ a versioning system for managing story versions across running orders. As a story version is incremented, any associated supporting materials, citations, and/or references could also be preserved for each new story version.

Regarding content approval, content writers and editors might request story content approval via auto-generated e-mail notification messages transmitted to an approvers list, for example. Approvers can then issue an e-mail response for updating the approval status of a story. The notification model also auto-generates feedback e-mail messages regarding stories' approvals and publication status to content writers, editors, and/or approvers in some embodiments.

An approval and notification mechanism could employ a role-based permission access model. For example, a journalist role can be configured to limit system access to view, create, and modify story content. However, a producer role can be configured with permissions to view, create, modify, approve, and publish story content. Hence, in the context of publishing through social media, the journalist is limited to requesting that a story be approved and published, and a producer is tasked with authorizing story content for publishing.

In addition, a content publishing authorization model could require that story content be approved before publishing to a social media web service. A user can issue a story approval request via a broadcast story editor UI, such as the example GUI 300 shown in FIG. 3. The approval request could be transmitted via the social media publishing system as an e-mail message or SMS message transmitted to an approver's recipient e-mail address. The approval request e-mail notification could include social media story contents for review by an approver.

An approver could issue a response to an approval request with: an approval of the story content, publishing of the story content, or rejection of the story content. The example GUIs 400, 500 in FIGS. 4 and 5 illustrate an approval before publishing mechanism. However, in other embodiments, an approver could click on a “Publish” button to both approve and publish social media content. A “Reject” button could be provided, in addition to the “Approve” button in the example GUI 400 in FIG. 4 for instance, to allow an approver to reject content.

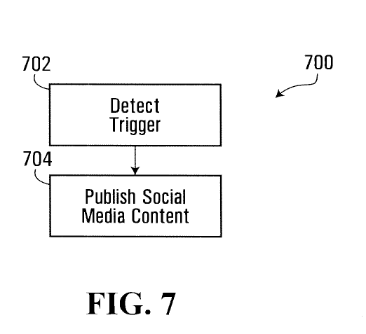

FIG. 7 is a flow diagram illustrating an example method. The example method 700 involves detecting a trigger associated with a live event video broadcast at 702, and publishing social media content to an online social media service at 704 responsive to the detection of the trigger.

The method 700 is intended solely for illustrative purposes, and other embodiments may involve variations of this method. For example, variations may be or become apparent on the basis of FIGS. 1 to 6 and the descriptions thereof. Any or all of the functions disclosed herein in the context of a system or an apparatus may similarly be embodied in a method.

What has been described is merely illustrative of the application of principles of embodiments of the invention. Other arrangements and methods can be implemented by those skilled in the art without departing from the scope of the present invention.

For example, the division of functions as shown in FIG. 1 is intended solely for illustrative purposes. Embodiments may be implemented with fewer, additional, and/or different components than those explicitly shown.

In addition, although described primarily in the context of production systems and methods, other implementations are also contemplated, as instructions stored on one or more non-transitory computer-readable storage media, for example.

1. (canceled)

2. An apparatus comprising:
a trigger detector to detect one or more triggers associated with broadcasting of a live event video broadcast by a broadcast system for reception by one or more receiving devices,
wherein said one or more triggers comprises at least one internally generated trigger,
said detection of the one or more triggers comprising monitoring of the broadcast system by the trigger detector;
a publication module operatively coupled to the trigger detector, to publish social media content to an online social media service responsive to the detection of the one or more triggers, said online social media service for use by one or more online social media service users; and
wherein said apparatus is integrated into said broadcast system.

3. The apparatus of claim 2, wherein said at least one internally generated trigger comprises an implicit trigger.

4. The apparatus of claim 2, wherein said detection of the one or more triggers further comprises monitoring of control signals used within the broadcast system, said control signals associated with broadcasting of the live event video broadcast.

5. The apparatus of claim 2, wherein the social media content comprises a portion of the live event video broadcast; and one of the one or more triggers is associated with completion of broadcast of the portion of the live event video broadcast.

6. The apparatus of claim 2,
the social media content comprising a portion of the live event video broadcast,
the trigger comprising completion of recording of the portion of the live event video broadcast.

7. The apparatus of claim 2, further comprising:
an interface to enable communication with a user,
further wherein the social media content is received via said interface,
the publication module publishing the social media content only after receipt of approval of the social media content through the interface from an authorized user who is authorized to approve the social media content.

8. The apparatus of claim 2, further comprising a content converter to convert the content into one or more respective formats for publication to one or more social media services responsive to detection of the trigger.

9. The apparatus of claim 2, the publication module determining whether the social media content is dependent upon completion of an event in addition to detection of the trigger, and delaying the publishing of the social media content until completion of the event where the social media content is dependent upon completion of the event.

10. The apparatus of claim 2, further comprising:
an interface to enable communication with a social media user; and
the publication module receiving incoming social media content from the social media user, and
publishing the incoming social media content to the live event video broadcast.

11. A method comprising:
detecting, by a trigger detector, one or more triggers associated with broadcasting of a live event video broadcast,
said one or more triggers comprising at least one internally generated trigger,
said broadcasting of the live event video broadcast performed by a broadcast system for reception by one or more receiving devices, and
said detecting further comprising monitoring of one or more signals;
publishing, by a publication module, social media content to an online social media service responsive to the detection of the one or more triggers,
said online social media service for use by one or more online social media service users; and
said broadcast system comprising said trigger detector and said publication module.

12. The method of claim 11, wherein the social media content comprises a portion of the live event video broadcast.

13. The method of claim 12, wherein the one or more triggers comprise completion of broadcast of the portion of the live event video broadcast.

14. The method of claim 12, further comprising:
recording, during broadcast, the portion of the live event video broadcast,
the one or more triggers comprising completion of recording of the portion of the live event video broadcast.

15. The method of claim 11, further comprising:
receiving the social media content via an interface;
requesting, prior to the publishing, approval of the social media content from an authorized user who is authorized to approve the social media content; and
the publishing being subject to receipt of approval of the social media content.

16. The method of claim 11, wherein the said at least one internally generated trigger comprises an implicit trigger.

17. The method of claim 11, further comprising:
determining whether the social media content is dependent upon completion of an event in addition to detection of the one or more triggers,
delaying the publishing of the social media content until completion of the event where the social media content is dependent upon completion of the event.

18. The method of claim 17, wherein the event comprises publication of additional social media content that is referenced in the social media content.

19. The method of claim 11, further comprising:
receiving incoming social media content;
publishing the incoming social media content to the live event video broadcast.

20. A method comprising:
detecting, by a trigger detector, one or more triggers associated with broadcasting of a live event video broadcast,
said one or more triggers comprising an internally generated trigger,
said broadcasting of the live event video broadcast performed by a broadcast system for reception by one or more receiving devices, and
said detecting further comprising monitoring of the broadcast system by the trigger detector;
publishing, by a publication module, social media content to an online social media service responsive to the detection of the one or more triggers,
said online social media service for use by one or more online social media service users; and
said broadcast system comprising said trigger detector and said publication module.
